(19) United States
(12) Patent Application Publication
(10) Pub. No.: US 2004/0190191 A1
(43) Pub. Date: Sep. 30, 2004

(54) Decorative panel for disk drive

(76) Inventor: Kuang-Yao Lee, Taipei City (TW)

Correspondence Address: BIRCH STEWART KOLASCH & BIRCH, PO BOX 747, FALLS CHURCH, VA, 22040-0747, US

(21) Appl. No.: 10/394,011

(22) Filed: Mar. 24, 2003

(51) Int. Cl. G11B 17/00

(52) U.S. Cl. 360/97.01

(57) ABSTRACT

The invention provides a decorative panel for disk drive, and a front side is provided on the decorative panel. Besides, the two sides of the front side are bent to form two holding portions, and the length and width of the front side is in accordance with that of the front shield panel of disk drive. By utilizing the two holding portions, the decorative panel for disk drive can be closely attached to the front shield panel of disk drive so that the decorative panel can be easily removed from and put back to the front shield panel.

### FIELD OF THE INVENTION

The invention relates to a decorative panel for disk drive and, more, particularly, to a decorative panel for disk drive that utilizes holding portions to be attached to the front shield panel of disk drive so that the decorative panel can be removed from and put back to the front shield panel easily.

### BACKGROUND OF THE INVENTION

Most people are getting more depending on computers in their daily lives because of wide applications in computers. Meanwhile, people's expectations from computer peripherals are getting more sophisticated as well. For instance, those systematized specifications for computer peripherals made by the manufacturers of conventional computer brand names can no longer satisfy the consumers who are looking for unique designs. On the other hand, because manufacturers of computer peripherals have been applying modularization in computer components manufacturing, it has become more convenient for consumers to do computer assembly or to upgrade their computer equipments on their own. In addition, many computer peripherals have been improved in their compatibility since their processing procedures have been modularized; therefore, the speed of do-it-yourself computer peripherals assembly has been enhanced as well.

As mentioned above, aside from requiring for compatibility in specifications of computer peripherals, many consumers are also pursuing more fashionable appearances for their computer peripherals. Unfortunately, most computer casings are produced in light gray color; therefore, most computer peripherals are also produced in the same color to go with the computer casings. However, not all the manufactures can produce exactly the same light gray color. In fact, color differences always occur in products from different manufacturers. Such problem may bother consumers who really care about how their computers look like. Another situation is that consumers may want to have a change in color for their computer peripherals, such as a disk drive. Conventionally, consumers might need to buy a replacement if they want to have a change in color. However, getting a replacement means spending money on a new thing, not to mention that it may also result in resource waste.

Therefore, in order to solve the above problems, the object of the invention is to provide a decorative panel that can be easily removed from and put back to a disk drive so that a user can replace a decorative-panel by himself/herself without buying another disk drive.

In order to achieve the above-mentioned object, the invention provides a front side of a decorative panel, wherein the two sides of the front side are bent to form two holding portions. Besides, the length and width of the front side is in accordance with that of the front shield panel on the disk drive. The decorative panel is closely attached to the front shield panel on the disk drive through holding made by the two holding portions so that the decorative panel can be easily and rapidly removed from and put back to the front shield panel.

The object and technical contents of the invention will be better understood through the description of the following embodiments with reference to the drawings.

### BRIEF DESCRIPTION OF THE DRAWINGS

FIG. 1 is a schematic perspective diagram of the contour of the invention.

FIG. 2 is schematic diagram of an embodiment of the invention.

FIG. 3 is a schematic diagram of another embodiment of the invention.

### DESCRIPTION OF THE PREFERRED EMBODIMENTS

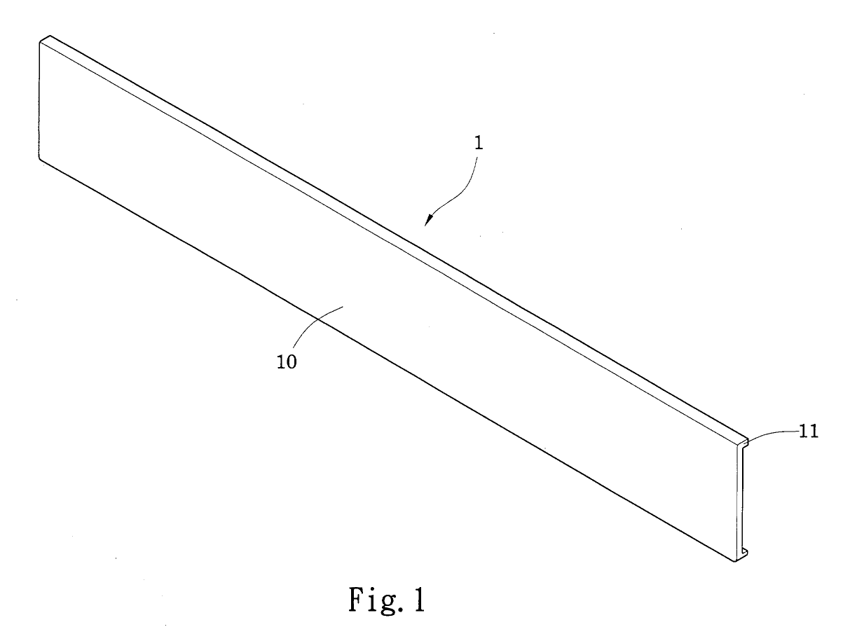

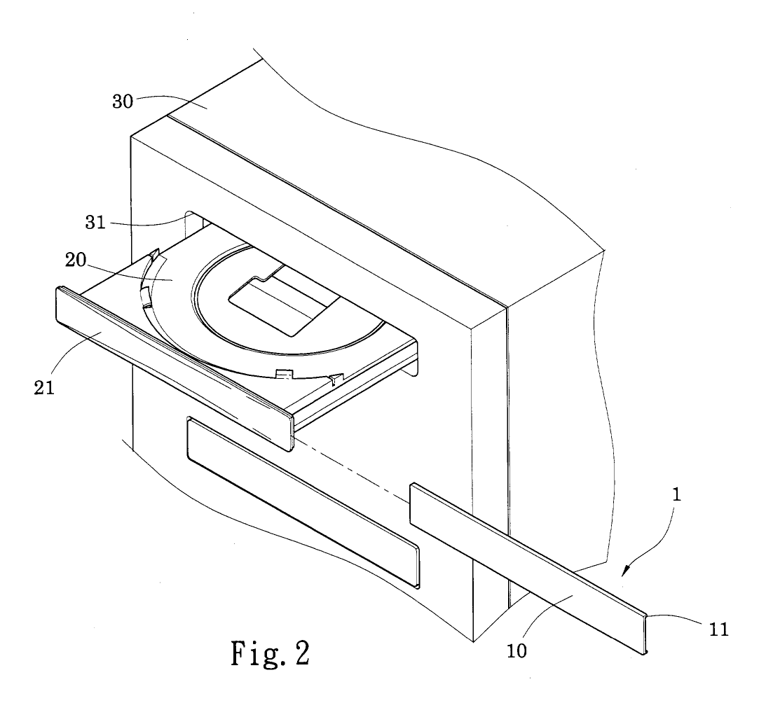

Referring to FIGS. 1 and 2, they are two schematic diagrams of a perspective contour and an embodiment of the invention respectively. As shown in Figs., a decorative panel for disk drive is disclosed in the invention, wherein a front side 10 is provided on the decorative panel 1, and the two sides of the front side 10 are bent to form two holding portions 11. The length and width of the front side 10 is in accordance with that of the front shield panel 21 on the disk drive 20. Besides, the thickness of the front side 10 as well as its holding portions 11 is very thin, only about 0.1 cm. The disk slot 31 is always slightly larger than the front shield panel 21 of the disk drive 20 in size when manufacturers of the computer casing 30 making the disk slot 31; therefore, a common difference can be tolerated among different manufacturers of disk drive. After the decoration panel 1 has been placed on the front shield panel 21 of the disk drive 20, the width of the front side 10 will be exactly in accordance with that of the disk slot 31 on the casing 30 so that the actions of pushing out and retracting back made by the disk drive 20 will not be affected by the decorative panel 1. In addition, the slit on the disk slot 31 of the disk drive 20 can be diminished as well.

When assembling, first, the disk drive 20 is pushed out from the disk slot 31, and then the decorative panel 1 will be horizontally placed on the front shield panel 21 of the disk drive 20. Because the two sides of the front side 10 are bent to form two holding portions 11, the two holding portions 11 are corresponding to the upper and lower sides of the front shield panel 21 of the disk drive 20. Therefore, by utilizing the holding portions 11, the front side 10 can be closely attached to the front shield panel 21 of the disk drive 20. Finally, the disk drive 20 will be retracted back to the computer casing 30, and the assembly of decorative panel 1 for disk drive 20 is completed.

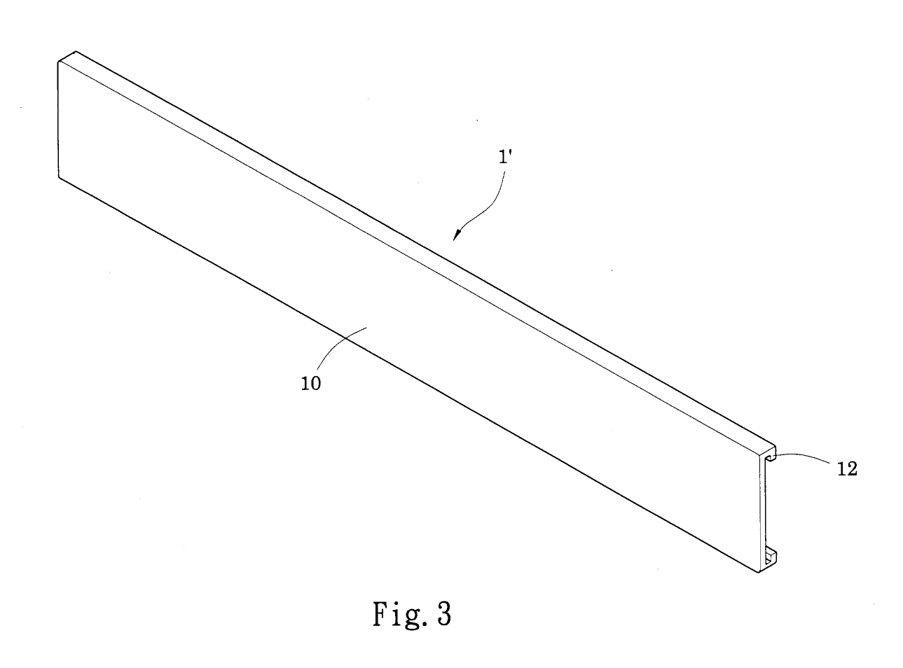

Next, referring to FIG. 3, it is a schematic diagram of another embodiment of the invention. As shown in FIG. 3, besides that the holding portions 11 of the front side 10 can be attached to the front shield panel 21 of the disk drive 20 shown in FIG. 2, the two holding portions 11 can also be extended to form two fastening portions 12, which can further fasten the front side 10 onto the front shield panel 21 of the disk drive 20 so as to ensure that the decorative panel 1′ will not fall off when being tapped, or to prevent from the situation that the vibration produced by the computer operation may cause the decorative panel 1 to drop.

In conclusion, the invention has the following advantages:

1. The invention can be assembled easily, and the user can choose an appropriate decorative panel 1 for disk drive according to the size and color that the user wants to go with the computer casing 30.

2. The thickness of the front side 10 as well as its holding portions 11 is very thin; therefore, when the front side 10 is assembled on the front shield panel 21 of the disk drive 20, the operation of the disk drive 20 will not be affected.

3. The invention is a decorative panel 1 that can be additionally added to the disk drive; therefore, there is no need to alter modules for the other computer peripherals.

4. The front shield panel 21 of the disk drive 20 plus the decorative panel 1 of the invention can diminish the slit of the disk slot 31 so that the probability for dust to get into the disk slot 31 will be reduced.

What is claimed is:

1. A decorative panel for disk drive, including a front side that is provided on the decorative panel, and two sides of the front side are bent to form two holding portions; also, the length and width of the front side is in accordance with that of the front shield panel of the disk drive; by utilizing the two holding portions, the decorative panel for disk drive can be closely attached to the front shield panel of the disk drive so that the decorative panel can be easily removed from and put back to the front shield panel.

2. The decorative panel for disk drive as claimed in claim 1, wherein the width of the front side is exactly in accordance with that of the disk slot on the disk drive.

3. The decorative panel for disk drive as claimed in claim 1, wherein the holding portions can be extended to form fastening portions.
